(19) United States
(12) Patent Application Publication
(10) Pub. No.: US 2023/0168725 A1
(43) Pub. Date: Jun. 1, 2023

(54) WIRELESS LAPTOP COOLING APPARATUS, SYSTEM AND METHOD

(71) Applicants: Aaron Hill, Joplin, MO (US); William Hill, JR., Joplin, MO (US)

(72) Inventors: Aaron Hill, Joplin, MO (US); William Hill, JR., Joplin, MO (US)

(21) Appl. No.: 18/054,941

(22) Filed: Nov. 14, 2022

Related U.S. Application Data
(60) Provisional application No. 63/283,328, filed on Nov. 26, 2021.

(51) Int. Cl. G06F 1/20; G05B 19/042

(52) U.S. Cl. CPC G06F 1/203; G05B 19/042; G05B 2219/50333

(57) ABSTRACT

An apparatus, system and method for cooling a laptop computer comprising a wireless laptop cooling apparatus and standalone computer program. The laptop cooling apparatus includes at least one fan driven by a battery pack or external power supply, the fan speeds being controlled by a computer program in response to laptop computer information including CPU and GPU processor temperatures. The computer program is an application running on the laptop computer to be cooled and is paired with the laptop cooling apparatus via, inter alia, a wireless protocol.

### CROSS REFERENCE TO RELATED APPLICATION

This application claims priority to U.S. Ser. No. 63/283,328 filed Nov. 26, 2021, entitled WIRELESS LAPTOP COOLING SYSTEM, the contents of which are incorporated herein by reference.

### TECHNICAL FIELD

The invention relates to thermal control devices, specifically cooling systems for laptop computers.

### BACKGROUND OF THE INVENTION

Portable self-contained personal computer systems, referred to herein as laptop computers, must pack the various components of a full size personal computer system including a mouse or touchpad, keyboard, motherboard including onboard central processing unit (CPU), hard disk drive or solid state hard drive, random access memory (RAM), a flatscreen monitor, power supply and distribution system including a battery or batteries, cooling system including a heatsink and a fan or fans, and often a graphics processing unit (GPU) or video card, camera, CD/DVD drive, and touchscreen, and all associated signal conditioning circuitry, into a compact form factor that can be easily carried or transported in, for example, a backpack.

Thermal regulation/control of critical component temperatures in such an enclosed compact environment represents a significant engineering challenge; electrical components naturally dissipate waste heat when electrical current experiences resistance and critical components such as the CPU and GPU begin to operate unreliably at high temperatures (generally around 200° F.). Further, the efficiency of laptop computer thermal control systems is constrained by several considerations: the compact form factor limits the placement, size and complexity of such systems, generally precluding large vents, numerous fans, or liquid cooling solutions; consumer interests and general use cases limit the acceptable level of fan noise and therefore fan size/power. Certain characteristics of laptop thermal control systems have become standardized, including large heat sinks which conduct heat from laptop electrical components to a radiating component having a plurality of thin fins in order to maximize surface area exposed to a driven air stream while minimizing flow disruption such that heat is transferred via forced convection from the radiating fins to the air stream, movement of said air stream being actuated by a centrifugal fan which draws cooler air in through downward-facing vents mounted on the laptop lower surface and expels heated air radially through vents located on the laptop side and/or back surfaces.

Although manufacturers may attempt to avoid overheating issues by careful selection of components and matching to available thermal control system heat dissipation capacity, there exist a number of reasons laptop overheating may be an issue: a user may desire to overclock a CPU or GPU, running it at faster than recommended clock speeds and generating more heat than usual; the operating environment may be less than ideal, with high temperatures or blocked fan intakes limiting heat dissipation; the laptop may not have been designed for certain uses or sustained levels of use and experience component degradation as a result. For example, users will commonly use laptop computers in place of full-sized personal computers, sometimes leaving them plugged in and turned on for extended periods.

Any laptop cooling solution must work within the standardized laptop thermal control system characteristics listed above in order to appeal to the majority of current laptop users. Because laptop computers are generally placed on flat surfaces, their downward-facing fan intake vents can suffer from impeded airflow. A thermal control system is heavily reliant on the ability of fans to drive a large volume of cooler air over hot components. Impeding this incoming airflow therefore impacts the performance of said laptop thermal control system. Further, impeding the air flow can require laptop fans to work harder to dissipate sufficient heat, leading to increased power draw and fan noise.

Various laptop cooling pads are available on the market which aim to improve airflow through said downward-facing laptop air intake vents by positioning external fans directly beneath the laptop fans in an attempt to increase the available air flow to said laptop fans. Additionally, some of said laptop cooling pads are elevated or tilted to provide increased clearance between the external fans and any proximate surface, thereby further improving airflow. Existing laptop cooling pads comprise a plurality of fans powered via one or more universal serial bus (USB) connections to the associated laptop, limiting power draw to the low voltage which can be provided by a laptop USB connection, typically 5V. Existing laptop cooling pads are also “dumb” accessories, in that they do not interface with the connected laptop in any meaningful way beyond drawing power. Further, they do not provide a user with any information or controls beyond a simple on/off switch or limited speed settings.

What is desired is an apparatus and system which improves airflow to the intake vents of a laptop computer, comprises, inter alia, a power supply capable of providing a higher voltage to fans than a USB supply, interfaces meaningfully with said laptop, and provides relevant information to a user. The invention provides such a solution.

### SUMMARY OF THE INVENTION

The invention is a laptop cooling apparatus and standalone computer program for improving airflow to the fan intake vents of a laptop computer, thereby cooling said laptop computer. Said laptop cooling apparatus comprises a housing, one or more fans, power supply/distribution including rechargeable battery and charging port, low-power integrated display such as an OLED or LCD screen, wireless transceiver using Bluetooth or other wireless communication protocol to communicate with said laptop. Said computer program is an application loaded and running on said laptop which interfaces with the laptop cooling via said wireless communication protocol and wireless transceiver. Said device fans are capable of moving a larger volume of air than existing laptop cooling pad solution fans due to the larger available power supply. The onboard display provides a user with relevant information at a glance such as laptop processor temperatures and/or laptop cooling apparatus fan speeds, while an associated computer program running on said laptop computer is able to interface directly with the laptop cooling apparatus in order to monitor laptop temperatures and command external fan rates or to command a system shutdown if critical temperature limits are exceeded.

To those skilled in the art to which this invention relates, many changes in construction and widely differing embodiments and applications of the invention will suggest themselves without departing from the scope of the invention as defined herein. The disclosures and the descriptions herein are purely illustrative and are not intended to be in any sense limiting.

### BRIEF DESCRIPTION OF THE DRAWINGS

For a better understanding of the invention including the features, advantages and specific embodiments, reference is made to the following detailed description along with accompanying Figures.

FIG. 1 is front view of an embodiment of the invention being a laptop cooling apparatus and system, showing the housing, shell or enclosure thereof (referred to as the “housing”) of the invention with a laptop computer positioned thereon;

FIG. 2A is front perspective view of an embodiment of the laptop cooling apparatus and system showing, inter alia, the front of the housing of the invention;

FIG. 2B is rear perspective view of an embodiment of the laptop cooling apparatus and system showing, inter alia, the rear of the housing of the invention;

FIG. 3 is a rear perspective cutaway view of an embodiment of the housing of the laptop cooling apparatus and system;

FIG. 4 is a screen shot of another aspect of the invention, being a graphical user interface (referred to as the “GUI”) as would be seen on a computer screen showing the operating parameters of the laptop cooling apparatus and system;

FIG. 5 is a backside view of a printed circuit board (referred to as the “PCB”) showing the traces and positions of the subcomponents that drive the indications on the GUI and the speed of the cooling fans;

FIG. 6 is a view of several components of the laptop cooling apparatus and system temporarily positioned outside of the housing to provide a better view thereof;

FIG. 7 is a block diagram of the processing components of the laptop cooling apparatus and system; and

FIG. 8 is a flow chart of the steps of a method of the invention.

### DETAILED DESCRIPTION

While the making and using of the disclosed embodiments of the invention is discussed in detail below, it should be appreciated that the invention provides many applicable inventive concepts which can be embodied in a wide variety of specific contexts. Some features of the preferred embodiments shown and discussed may be simplified or exaggerated for illustrating the principles of the invention.

The invention is a laptop cooling apparatus and system which includes hardware components and software components for improving airflow toward the fan intake vents of a laptop computer, thereby cooling said laptop computer. Said laptop cooling apparatus comprises a housing, one or more high performance fans, onboard microcontroller including processor and nonvolatile memory, signal conditioning circuitry, power supply/distribution components including high capacity rechargeable batteries such as lithium-ion batteries and charging port, OLED or LCD display screen, wireless transceiver operable to communicate with said laptop computer via Bluetooth or other wireless communication protocol, and physical controls operable to turn the laptop cooling apparatus on or off among other functions.

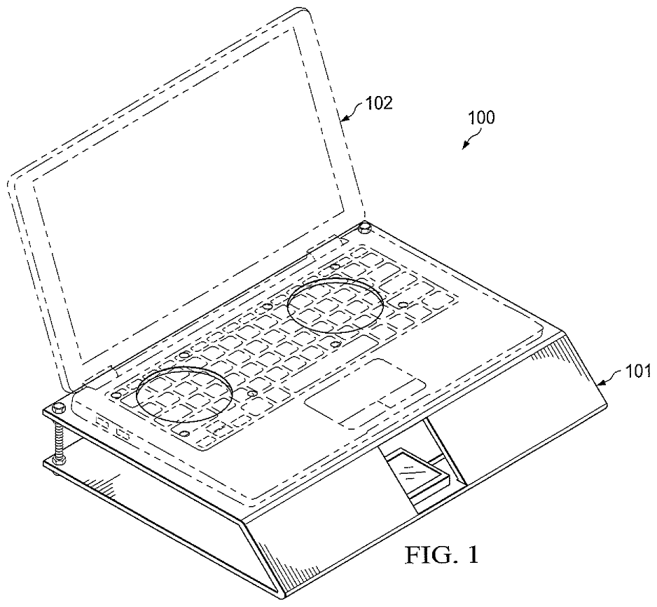

Referring now to the Figures, FIG. 1 is front view of the housing 101 of a laptop computer cooling apparatus and system 100, with a laptop computer 102 (prior art) located thereon.

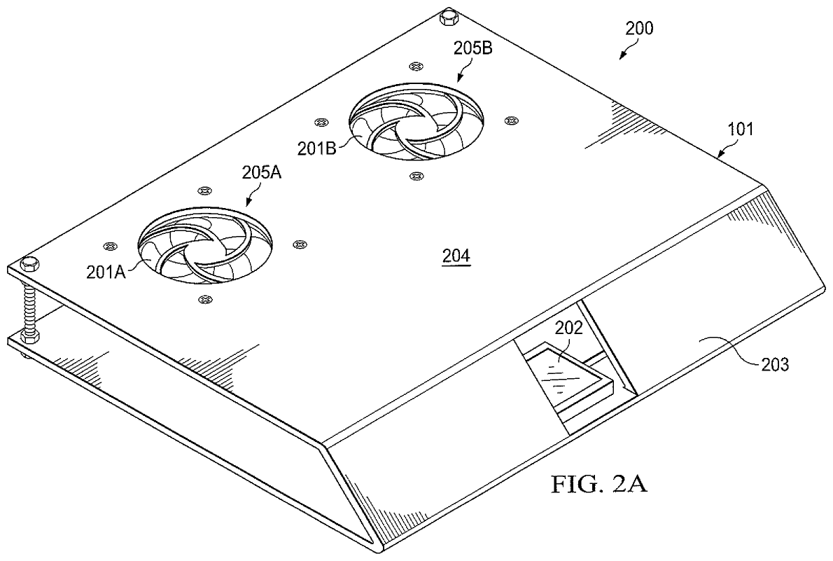

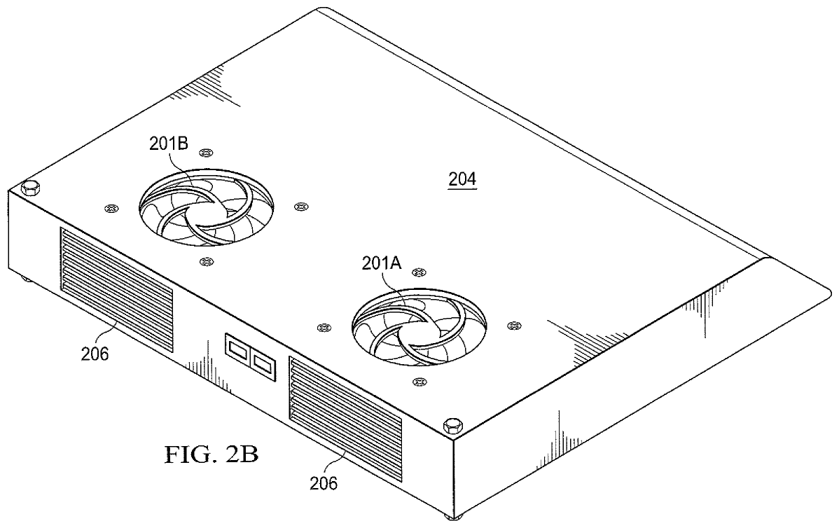

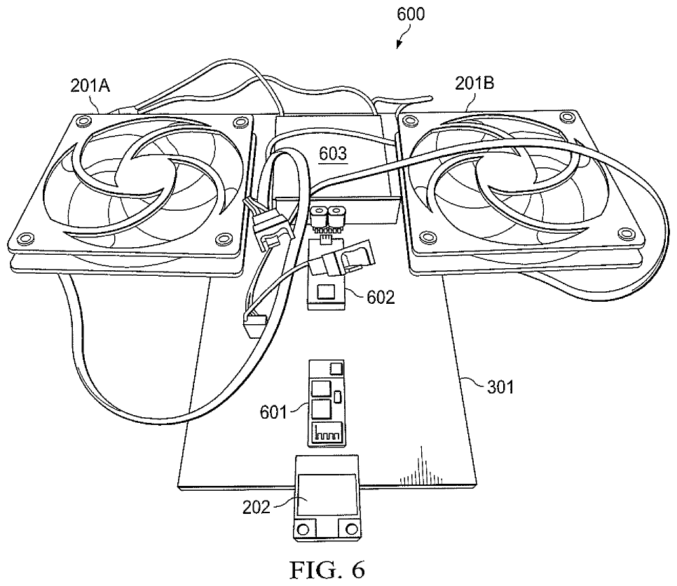

As seen in FIG. 1, said housing 101 has a height defined as the vertical distance between a top plate and a bottom plate of said housing 101, said height being dimensioned to provide sufficient clearance to allow optimal airflow to one or more internal fans (seen in FIGS. 2 and 6), said clearance in the preferred embodiment of the invention being around 0.5 inches.

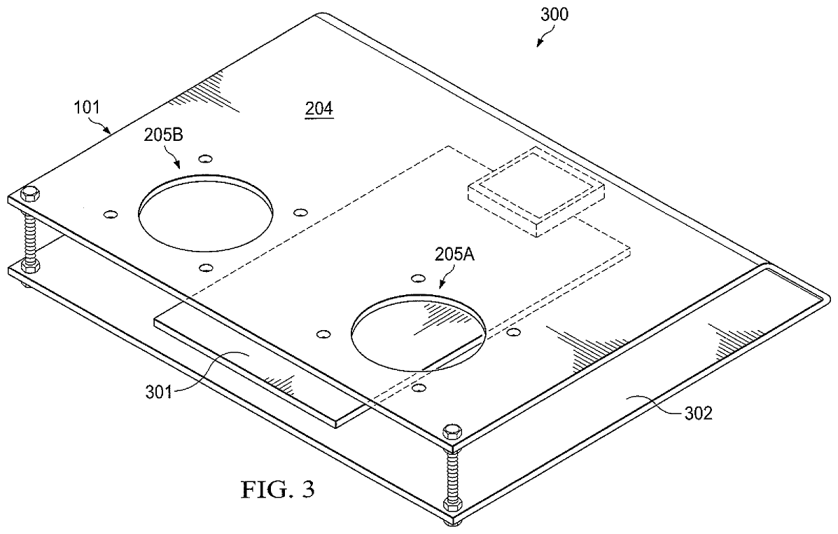

Referring to FIG. 2A, a front perspective view 200 of the laptop cooling apparatus and system 100 is wherein a fuller view of the housing 101 is provided. As seen therein, a housing top plate 204 is dimensioned to accommodate a laptop computer. A housing bottom plate (seen in FIG. 3, 302) is coupled to said top plate 204 via two or more spacing bolts or vertical support beams or side walls located between the top plate 204 and bottom plate 302 around the perimeter of said housing 101. A front plate 203 is coupled to said top plate 204 and bottom plate, said housing top plate 204 comprising an upper and lower surface and an opening or openings 205A, 205B extending vertically therethrough, each of said openings 205A, 205B being positioned over a fan 201A, 201B and sized to maximize the associated vertical airflow, each of said fans 205A, 205B being located inside said housing 101 and mounted to the lower surface of said housing 101 top plate 204 such that air is drawn in through the lateral openings (seen in FIG. 2B, 206) between the top plate 204 and bottom plate 302 and directed upwards to the laptop computer air intake vents. The housing 101 further comprises one or more mesh filter screens over the laptop cooling apparatus fan intakes and/or over the laptop cooling apparatus fan exhaust openings, in order to reduce dust or debris transmitted by the laptop cooling apparatus fan air streams to the laptop fan air intakes. In the preferred embodiment, said housing 101 comprises two high-performance 120 mm fans 201A, 201B and said housing top plate 204 comprises two corresponding openings 205A, 205B.

The front plate 203 of said housing 101 is positioned at an angle, typically 45 degrees. In one embodiment of the invention, said front plate 203 comprises on its outward facing surface an OLED or LCD screen 202 (referred to as a “screen”), said screen 202 displaying relevant device information including laptop CPU and/or GPU temperatures, CPU and/or GPU clock speeds, and device fan speed. In another embodiment, said front plate 203 comprises an opening through which an OLED or LCD screen 202 is visible, said OLED or LCD screen 202 being in this embodiment mounted inside said housing 101. Screen 203 is coupled to PCB 301 (seen in FIG. 3). Said coupling can be via ribbon conductor, fiber optic, copper wiring or the screen 203 can be directly mounted on or near the edge of PCB 301. In an embodiment the top plate 204, front plate 203, and bottom plate 302 are made out of a metal alloy.

FIG. 2B is rear perspective view of an embodiment of the laptop cooling apparatus and system showing, inter alia, the rear of the housing of the invention with intake vents 206 dimensioned and operable to allow the ingress of air into the housing 101 which is then pulled through fans 201A, 201B,

FIG. 3 is a rear perspective cutaway view 300 of an embodiment of the housing 101 of the laptop cooling apparatus and system. As seen therein, printed circuit board (referred to as PCB) 301 is either coupled to the bottom plate 302 or hanging using spacers from top plate 204. The gap between the top plate 204 and bottom plate 302 is preferably between 0.5 inches and 4 inches and the PCB preferably has between 0.25 inches and 2 inches of vertical clearance between its planar surface sufficient to allow clearance for its subcomponents including its batteries, chipsets, microcontroller(s) and the screen 202. The clearance of the PCB between the top plate 204 and bottom plate 302 is also dependent on the overall clearance between the top plate 204 and bottom plate 302, which, as noted above, is preferably between .5 inches and 4 inches. As seen in FIG. 3, top plate 204 includes openings 205A, 205B extending therethrough, each of said openings 205A, 205B being positioned over a fan (seen in FIG. 2A, 201A, 201B) and sized to maximize the associated vertical airflow of each of said fans 205A, 205B upwards to the laptop computer air intake vents.

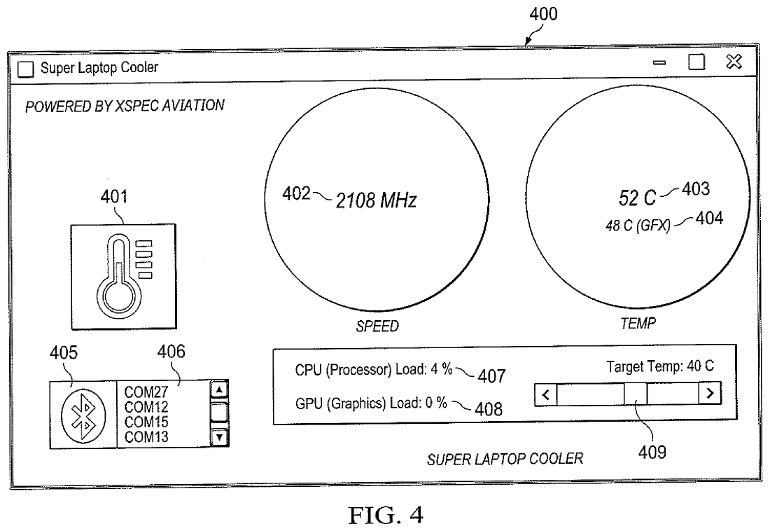

FIG. 4 is a screen shot of another aspect of the invention, being a graphical user interface 400 (referred to as the “GUI”) as would be seen on a computer screen showing the operating parameters of the laptop cooling apparatus and system 100 and a laptop computer 102 coupled thereto. As seen on such GUI 400, such parameters include an overheat protection indicator 401 which is driven by and coupled to a temperature sensor in the housing, preferably on the PCB; laptop computer 102 central processing unit (CPU) clock speed indicator 402 driven by, and coupled to the laptop computer 102; CPU temperature 403 driven by, and coupled to the laptop computer 102; graphics processing unit (GPU) temperature 404, driven by, and coupled to the GPU within the laptop computer 102; Bluetooth connection status 405 showing the status of the connection between the laptop computer cooling apparatus and system 100 and the laptop computer 102; Bluetooth communication port 406 selection showing which interface is selected between the laptop computer cooling apparatus and system 100 and the laptop computer 102; laptop computer 102 CPU workload status 407; laptop computer 102 GPU workload status 408; and target temperature 409 for the temperature of the laptop computer CPU. In the forgoing, each of the temperature measurements can be any of one selected from the group consisting of Fahrenheit, Celsius, or Kelvin.

The GUI 400 is driven by a computer program being a set of instructions in the form of computer code to be loaded and run on the laptop computer 102 to be cooled, said computer program being operable to access or determine, inter alga, laptop computer 102 information including CPU temperatures, CPU clock speeds, CPU aggregate speed, GPU temperatures, GPU clock speeds, laptop protection status, laptop communication status, laptop fan speeds, laptop battery voltage, and laptop battery charge percentage. Said computer program is further operable to accept user input and set desired target laptop CPU or GPU temperatures or temperature-fan speed response profiles and then wirelessly communicate the target temperatures, CPU and GPU temperatures, and other laptop information via a Bluetooth module (seen in FIG. 6, 601) or other wireless communication protocol such as IEEE 802.11 WiFi to the microcontroller (seen in FIG. 6, 602) so that the laptop cooling apparatus and system 100 can locally determine required laptop cooling apparatus fan 201A, 201B speeds. In another embodiment, the computer program is operable to determine required laptop cooling apparatus fan 201A, 201B speeds and transmit the same along with laptop information such as CPU and/or GPU temperatures via a Bluetooth module (seen in FIG. 6, 601) or other wireless communication protocol to the microcontroller 602 (seen in FIG. 6) so that the laptop cooling apparatus and system 100 can command the speed of the fans 201A, 201B. The computer program is also operable to accept user input and configure laptop cooling apparatus components such as LED behavior and OLED/LCD display screen 202 contents. The computer program is further operable to display on the laptop computer 102 screen in an application window any or all of the accessed or measured laptop and laptop cooling apparatus parameters and user-defined configurations via GUI 400.

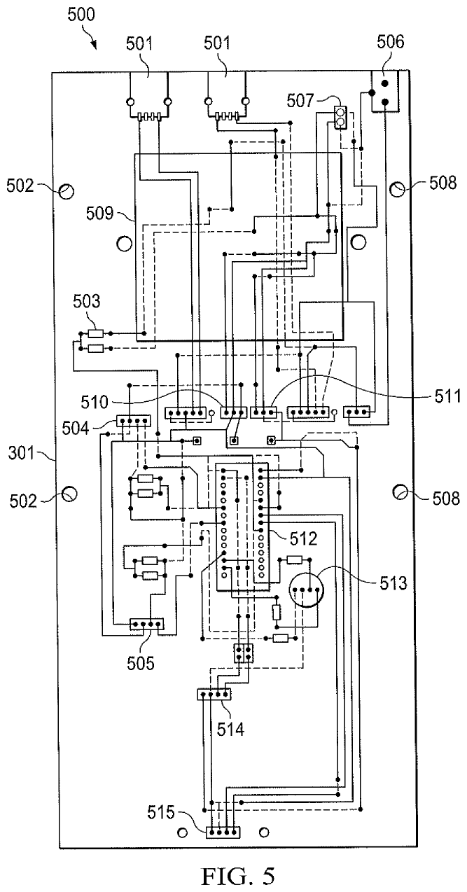

FIG. 5 is a backside view 500 of PCB 301 showing traces and positions of the subcomponents that drive the indications on the GUI 400 and the speed of the fans 201A, 201B. More specifically, the PCB has ports, mount holes and copper traces that couple the various subcomponents seen in FIG. 6. PCB 500 includes, inter alga, USB peripheral charge ports 501, such charge ports being compliant with any appropriate standards related form factor and voltage, current and resistance requirements; fan 201A screw mount holes 502, preferably 120 mm dimensioned holes; a battery charge detection voltage divider 503; fan 201A connection 504, preferably a 4 pin pulse width modulation (PWM) connection; fan 201B connection 505, preferably a 4 pin PWM connection; a direct current (DC) charge input 506, preferably a lithium ion barrel jack connector; fan 201B screw mount holes 502, preferably 120 mm dimensioned holes; battery pack coupling 509, preferably for a 13.247.6 volt lithium ion battery; voltage regulator 511; microcontroller coupling 512, for coupling a microcontroller 602 such as an Arduino Nano or similar; LED indicator 513, such as an RGB LED that is PWM controlled by the microcontroller 512; Bluetooth module 601 connection 514, such as one that complies with the serial port profile (SPP) and the connection or coupling 515 for the screen 202.

FIG. 6 is a view of several components 600 of the laptop cooling apparatus and system 100 temporarily positioned on a frame for PCB 301 outside of the housing 101 to provide a better view thereof. Referring to FIG. 6, the laptop cooling apparatus and system 100 further comprises external and internal circuitry and components operable to charge an onboard rechargeable battery pack 603, such as a lithium ion battery pack, and condition and distribute power to internal components, wirelessly send and receive data to and from a laptop computer 102 via a wireless transceiver and wireless communication protocol such as Bluetooth via a Bluetooth module 601, store in nonvolatile memory and execute instructions in the form of computer code by microcontroller 602 that are operable to determine and command fan 201A, 201B speeds in response to user input and/or laptop internal temperature data derived from one or more temperature sensors inside laptop computer 102, as determined by an associated computer program running on said laptop computer 102 and transmitted to the microcontroller 602 via said wireless transceiver and wireless communication protocol such as Bluetooth module 601, and display a user-defined selection of information on an integrated OLED or LCD display screen 202.

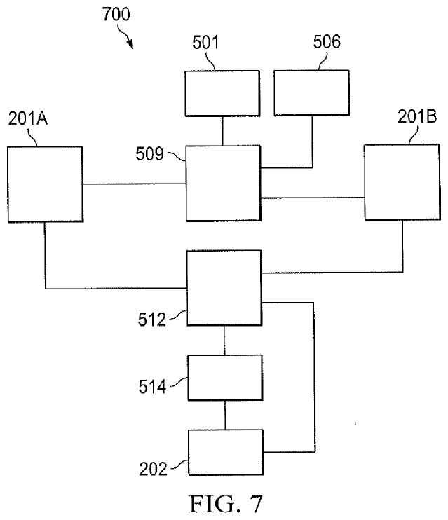

FIG. 7 is a block diagram 700 of the coupling of some, but not all, of the active processing components of the laptop cooling apparatus and system 101. As seen therein, USB charge port 501 is coupled to, inter alia, battery pack 603 coupling 509, which in turn is coupled to direct current (DC) charge input 506 and fans 201A, 201B. Fans 201A, 201B are coupled to microcontroller 602 coupling 512, which in turn is coupled to Bluetooth module 601 connection 514. Screen 202 is coupled to microcontroller 602 coupling 512 and in some embodiments, Bluetooth module 601 connection 514.

Synthesizing the invention as shown in FIG. 1-7, the invention is shown to be a laptop cooling apparatus, comprising a housing having a top plate with at least one aperture or opening. There is at least one fan positioned within the housing underneath the top plate and axially aligned with the at least one aperture or opening. Each of the at least one fans having fan blades and further being positioned within the housing to redirect air from within the housing, through the apertures or openings, to a laptop computer. A microcontroller is coupled to the at least one fan and operable to control the rotational speed of the fan blades of the at least one fan. A laptop cooling apparatus communication module is coupled to the microcontroller. A power supply and power distribution circuitry including a rechargeable battery and a charging port, couples the power supply and power distribution circuitry to the at least one fan, microcontroller and communication module. The microcontroller is configured to receive laptop computer operating parameter signals from the laptop cooling apparatus communication module, said laptop cooling apparatus communication module receiving such operating parameter signals from a laptop computer via a laptop computer communication module.

The invention further comprises a computer program comprising instructions stored on a computer readable medium of a laptop computer, which, when executed, retrieves operating parameters of the laptop computer and transmits such operating parameters from a laptop computer communication module to the laptop cooling apparatus communication module, wherein the operating parameters comprise any one or more of the following laptop computer parameters: central processing unit (CPU) temperatures, CPU clock speeds, CPU aggregate speed, graphics processing unit (GPU) temperatures, GPU clock speeds, laptop protection status, laptop communication status, laptop computer fan speeds, laptop computer battery voltage, and laptop computer battery charge percentage.

The microcontroller has stored thereon microcontroller computer code in the form of instructions stored on a computer readable medium of the microcontroller, said instructions, when executed, operable to process the operating parameters received from the laptop cooling apparatus communication module and based thereon determine and command the rotational speeds of the fan blades of the at least one fan. The computer program comprising instructions stored on a computer readable medium of the laptop computer is operable to display one or more of the operating parameters on a graphical user interface (GUI) of a laptop computer.

A further embodiment of the invention is a laptop cooling apparatus and system for improving airflow toward the fan intake vents of a laptop computer comprising hardware components and software components. The hardware components further comprise a housing having a top plate with at least one opening; at least one fan coupled to the top plate axially aligned with the at least one opening, the fan having a plurality of blades that rotate when powered, the fan blades, when rotated, oriented pull air from within the housing and eject the air vertically out of the housing so as to impact a laptop computer that has been positioned on the top plate of the housing. The at least one fan is operable to be powered by a power supply selected from the group of an external power supply and an internal battery power supply.

A microcontroller is coupled to the power supply and to the at least one fan and operable to control the power applied to the at least one fan. A laptop cooling apparatus communication module is coupled to the microcontroller operable to send and receive data to and from a laptop computer communication module. The software components further comprise microcontroller computer code in the form of instructions stored on a computer readable medium of the microcontroller, said instructions, when executed, operable to receive from the laptop cooling apparatus communication module, data from a laptop computer communication module, and based on the values of the data, determine and command the rotational speeds of the fan blades of the at least one fan.

In a further embodiment, the housing has two openings, and two fans coupled thereto, each said fan being operable to be powered by a power supply selected from the group of an external power supply and an internal battery power supply and a microcontroller coupled to the power supply and to the two fans and operable to control the power applied to the two fans.

In a further embodiment, both the external power supply and the internal battery power supply are used separately or in tandem to power the at least one fan, the microcontroller and the laptop cooling apparatus communication module. The invention further comprises circuitry and components coupled to the microcontroller and internal battery power supply operable to charge the internal battery power supply from the external power supply. The laptop cooling apparatus communication module is a wireless communication module configured to receive, process and transmit communications signals between the laptop cooling apparatus and a laptop computer, the communication signals being structured based on a protocol selected from the group consisting of the Bluetooth standard or IEEE 802.11 WiFi standard.

The invention also comprises the above-described laptop cooling apparatus and system in combination with a laptop computer, said laptop computer having a laptop computer communication module in communication with the laptop cooling apparatus communication module. The laptop computer also has computer code in the form of instructions stored on a computer readable medium, said instructions, when executed, operable to receive data regarding internal parameters of laptop computer and transmit such data from the laptop cooling apparatus communication module to the laptop cooling apparatus communication module, such data being processed by the microcontroller to determine and command the rotational speeds of the fan blades of the at least one fan. The laptop cooling apparatus and system is operable to process data, wherein the data regarding internal parameters of laptop computer is transmitted from the laptop computer apparatus communication module and received by the laptop cooling apparatus communication module, and said data comprises any one or more of the following laptop computer parameters: central processing unit (CPU) temperatures, CPU clock speeds, CPU aggregate speed, graphics processing unit (GPU) temperatures, GPU clock speeds, laptop protection status, laptop communication status, laptop computer fan speeds, laptop computer battery voltage, and laptop computer battery charge percentage. The data regarding internal parameters of the laptop computer and the results of the processing of such data by the microcontroller is transmitted between the laptop computer communication module and the laptop cooling apparatus communication module and is processed by the laptop computer so as to display values representing such data on a graphical user interface (GUI) on a laptop computer screen.

The microcontroller computer code in the form of instructions stored on a computer readable medium of the microcontroller, when executed, is operable to control the rotational speed of the fan blades of the at least one fan using analog signals or pulse width modulation (PWM). Further, the microcontroller computer code in the form of instructions stored on a computer readable medium of the microcontroller, when executed, is operable to balance the energy consumption of the at least one fan using pulse width modulation (PWM) with the desired level of cooling required by a laptop computer.

The invention further comprises a screen coupled to the housing, said screen being comprised of an array of light emitting diodes (LEDs), operable to indicate selected operating status parameters of the laptop cooling apparatus, said screen being coupled to the communication module and microcontroller. In an embodiment, the selected operating status parameters of the laptop cooling apparatus comprise an on-off indicator. In an embodiment, the rotational speed of the at least one fan is externally powered by either alternating current (AC) or direct current (DC).

In an embodiment, the laptop cooling apparatus in combination with the computer program is a laptop cooling system operable to measure or access laptop computer 102 internal temperature, compare the same against a stored target temperature, and determine optimal fan speeds to reach or maintain said target temperature while limiting power draw in order to improve battery life. Said target temperature may be user determined and may include temperature response profiles to set fan 201A, 201B speeds according to several target temperatures. The laptop cooling apparatus and system 100 can be configured via the computer program to play an audible alert through the laptop computer 102 speakers or command system shutdown of the laptop at user-defined critical temperatures.

In another embodiment, said laptop cooling apparatus further comprises one or more USB ports powered by said battery, said laptop cooling apparatus thus being capable of acting as a USB power bank. Additionally, the laptop cooling apparatus and system 100 may include user-accessible external memory such as a hard disk drive, solid-state drive, or flash memory, a USB 2.0 and/or USB 3.0 hub comprising one or more USB ports for external accessories, and other connections including HDMI or RJ45. In a further embodiment, said housing 101 includes thereon a plurality of multi-colored light-emitting diodes (LEDs), said LEDs being programmable via said computer program to change colors or brightness in response to parameters such as laptop CPU or GPU temperature, laptop computer screen content, CPU or GPU clock speed, audio, or other user-defined parameters and behaviors.

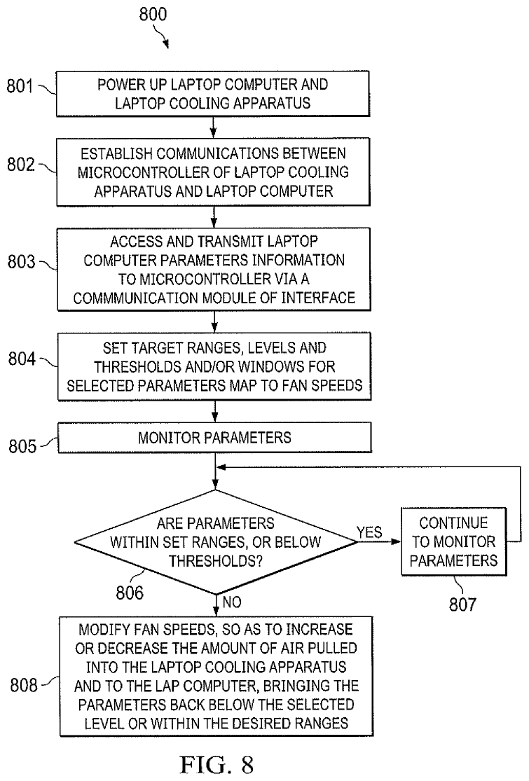

FIG. 8 is flow chart of the steps 800 of a method of the invention. To operate the laptop cooling apparatus and system 100, a user powers 801 the laptop cooling apparatus either by applying an external or internal power supply and turns the unit on via a physical switch to begin battery-powered operation. Once on or plugged in, microcontroller 602 will communicate 802 with the laptop computer 102 either automatically establish wireless communication with the laptop computer 102 to be cooled by pairing via Bluetooth module 601 or other wireless communication protocol or the user can open the computer program to manually establish wireless communication via the same. Once the laptop cooling apparatus and system 100 and laptop computer 102 are successfully paired, the computer program will access 803 laptop computer 102 information including CPU temperature and clock speed and transmit these data wirelessly to microcontroller 602 via a communication module or interface. Other information which may be accessed and sent from laptop computer 102 to microcontroller 102 via Bluetooth module 601 includes CPU aggregate speed, GPU temperatures, GPU clock speeds, laptop protection status, laptop communication status, fan speeds, laptop and/or laptop cooling apparatus battery voltage, laptop and/or laptop cooling apparatus battery charge percentage (either graphically or alpha-numerically), and any other custom alpha-numeric data the user may interactively input into a laptop cooling system computer program. In an embodiment, the computer program uses the OpenHardwareMonitor libraries to access computer health and performance data. Target ranges, levels and thresholds and/or windows are set 804 for selected parameters and are mapped to fan 201A, 201B rotational speeds. These parameters are monitored 805. So long as the parameters are within the set ranges or below selected trigger levels 806, monitoring continues 807. If any of the trigger thresholds are met or are outside the desired ranges, the rotational fan speeds are modified 808 so as increase or decrease the amount of air pulled into the housing 101 and being used to cool the laptop computer thus bringing the parameters back below or above the selected levels or within the desired ranges. 20.

The method of improving airflow toward the fan intake vents of a laptop computer comprises the steps of powering up a laptop computer and a laptop cooling apparatus; establishing communications between a microcontroller of the laptop cooling apparatus and laptop computer; accessing and transmitting laptop computer parameters information to the microcontroller via a communication module or interface; setting target ranges, levels and thresholds and/or windows for at least one selected parameter; mapping the selected parameters to one or a plurality of rotational fan speeds; monitoring the parameters; checking periodically to determine of the parameters are within set ranges, or below set thresholds and if so, continuing to monitor the parameters; and modifying the rotational fan speed so as to increase or decrease the amount of air being used to cool the laptop computer as to bring the parameters back below the selected level or within the desired ranges.

In an embodiment of the invention, the laptop cooling apparatus battery pack comprises four 18650 lithium-ion batteries outputting approximately 15V. The laptop cooling apparatus power distribution system comprises a 12V regulator which delivers 12V to each of the two fans, said fans being 4-pin PWM fans commonly found in desktop personal computers. The laptop cooling apparatus power distribution system further comprises a 5V regulator to provide power to other components such as the wireless transceiver and OLED or LCD display. This configuration of the invention can run for 8-10 hours on a full battery charge.

The embodiments shown and described above are only exemplary. Even though numerous characteristics and advantages of the invention have been set forth in the foregoing description, the disclosure is illustrative only and changes may be made within the principles of the invention to the full extent indicated by the broad general meaning of the terms used herein. Various alterations, modifications and substitutions can be made to the disclosed invention and the system that implements the invention without departing in any way from the spirit and scope of the invention

We claim:

1. A laptop cooling apparatus, comprising:
a housing having a top plate with at least one aperture or opening;
at least one fan positioned within the housing underneath the top plate and axially aligned with the at least one aperture or opening;
each of the at least one fan having fan blades and further being positioned within the housing to redirect air from within the housing, through the apertures or openings, to a laptop computer;
a microcontroller coupled to the at least one fan and operable to control the rotational speed of the fan blades of the at least one fan;
a laptop cooling apparatus communication module coupled to the microcontroller;
a power supply and power distribution circuitry including a rechargeable battery and a charging port, the power supply and power distribution circuitry coupling each of the at least one fan, microcontroller and communication module; and
the microcontroller configured to receive laptop computer operating parameter signals from the laptop cooling apparatus communication module, said laptop cooling apparatus communication module receiving such operating parameter signals from a laptop computer via a laptop computer communication module.

2. The laptop cooling apparatus of claim 1, further comprising a computer program comprising instructions stored on a computer readable medium of a laptop computer, which, when executed, retrieves operating parameters of the laptop computer and transmits such operating parameters from a laptop computer communication module to the laptop cooling apparatus communication module.

3. The laptop cooling apparatus of claim 2, wherein the operating parameters comprise any one or more of the following laptop computer parameters: central processing unit (CPU) temperatures, CPU clock speeds, CPU aggregate speed, graphics processing unit (GPU) temperatures, GPU clock speeds, laptop protection status, laptop communication status, laptop computer fan speeds, laptop computer battery voltage, and laptop computer battery charge percentage.

4. The laptop cooling apparatus of claim 3, wherein the microcontroller has stored thereon microcontroller computer code in the form of instructions stored on a computer readable medium of the microcontroller, said instructions, when executed, operable to process the operating parameters received from the laptop cooling apparatus communication module and based thereon determine and command the rotational speeds of the fan blades of the at least one fan.

5. The laptop cooling apparatus of claim 4, further comprising wherein the computer program comprising instructions stored on a computer readable medium of a laptop computer is operable to display one or more of the operating parameters on a graphical user interface (GUI) of a laptop computer.

6. A laptop cooling apparatus and system for improving airflow toward the fan intake vents of a laptop computer, comprising:
hardware components and software components, wherein the hardware components further comprise:
a housing having a top plate with at least one opening;
at least one fan coupled to the top plate axially aligned with the at least one opening, the fan having a plurality of blades that rotate when powered, the fan blades, when rotated, oriented pull air from within the housing and eject the air vertically out of the housing so as to impact a laptop computer that has been positioned on the top plate of the housing;
the at least one fan operable to be powered by a power supply selected from the group of an external power supply and an internal battery power supply;
a microcontroller coupled to the power supply and to the at least one fan and operable to control the power applied to the at least one fan;
a laptop cooling apparatus communication module coupled to the microcontroller operable to send and receive data to and from a laptop computer communication module;
and wherein the software components further comprises microcontroller computer code in the form of instructions stored on a computer readable medium of the microcontroller, said instructions, when executed, operable to receive from the laptop cooling apparatus communication module, data from a laptop computer communication module, and based on the values of the data, determine and command the rotational speeds of the fan blades of the at least one fan.

7. The laptop cooling apparatus and system of claim 6, wherein the housing has two openings, and two fans coupled thereto, each said fan being operable to be powered by a power supply selected from the group of an external power supply and an internal battery power supply; and
a microcontroller coupled to the power supply and to the two fans and operable to control the power applied to the two fans.

8. The laptop cooling apparatus and system of claim 6, wherein both the external power supply and the internal battery power supply are used separately or in tandem to power the at least one fan, the microcontroller and the laptop cooling apparatus communication module.

9. The laptop cooling apparatus and system of claim 8, further comprising circuitry and components coupled to the microcontroller and internal battery power supply operable to charge the internal battery power supply from the external power supply.

10. The laptop cooling apparatus and system of claim 6, wherein the laptop cooling apparatus communication module is a wireless communication module configured to receive, process and transmit communications signals between the laptop cooling apparatus and a laptop computer, the communication signals being structured based on a protocol selected from the group consisting of the Bluetooth standard or IEEE 802.11 WiFi standard.

11. The laptop cooling apparatus and system of claim 6, in combination with a laptop computer.

12. The laptop cooling apparatus and system of claim 6, in combination with a laptop computer, said laptop computer having a laptop computer communication module in communication with the laptop cooling apparatus communication module;
the laptop computer having computer code in the form of instructions stored on a computer readable medium, said instructions, when executed, operable to receive data regarding internal parameters of laptop computer and transmit such data between the laptop cooling apparatus communication module and the laptop cooling apparatus communication module, such data being processed by the microcontroller to determine and command the rotational speeds of the fan blades of the at least one fan.

13. The laptop cooling apparatus and system of claim 12, wherein the data regarding internal parameters of laptop computer is transmitted from the laptop computer apparatus communication module and received by the laptop cooling apparatus communication module, said data comprising any one or more of the following laptop computer parameters: central processing unit (CPU) temperatures, CPU clock speeds, CPU aggregate speed, graphics processing unit (GPU) temperatures, GPU clock speeds, laptop protection status, laptop communication status, laptop computer fan speeds, laptop computer battery voltage, and laptop computer battery charge percentage.

14. The laptop cooling apparatus and system of claim 13, wherein the data regarding internal parameters of laptop computer and the results of the processing of such data by the microcontroller is transmitted between the laptop computer communication module and the laptop cooling apparatus communication module and is processed by the laptop computer so as to display values representing such data on a graphical user interface (GUI) on a laptop computer screen.

15. The laptop cooling apparatus and system of claim 6, wherein the microcontroller computer code in the form of instructions stored on a computer readable medium of the microcontroller, when executed, is operable to control the rotational speed of the fan blades of the at least one fan using pulse width modulation (PWM).

16. The laptop cooling apparatus and system of claim 15, wherein the microcontroller computer code in the form of instructions stored on a computer readable medium of the microcontroller, when executed, is operable to balance the energy consumption of the at least one fan using pulse width modulation (PWM) with the desired level of cooling required by a laptop computer.

17. The laptop cooling apparatus and system of claim 6, further comprising coupled to the communication module and microcontroller, a screen coupled to the housing, said screen being comprised of an array of light emitting diodes (LEDs), operable to indicate selected operating status parameters of the laptop cooling apparatus.

18. The laptop cooling apparatus and system of claim 17, wherein the selected operating status parameters of the laptop cooling apparatus comprise an on-off indicator.

19. The laptop cooling apparatus and system of claim 6, wherein the rotational speed of the at least one fan is externally powered by either alternating current (AC) or direct current (DC).

20. A method of improving airflow toward the fan intake vents of a laptop computer comprising the steps of:
powering up a laptop computer and a laptop cooling apparatus;
establishing communications between a microcontroller of the laptop cooling apparatus and laptop computer;
accessing and transmitting laptop computer parameters information to the microcontroller via a communication module or interface;
setting target ranges, levels and thresholds and/or windows for at least one selected parameter;
mapping the selected parameters to one or a plurality of rotational fan speeds;
monitoring the parameters;
checking periodically to determine of the parameters are within set ranges, or below set thresholds and if so, continuing to monitor the parameters; and
modifying the rotational fan speed so as to increase or decrease the amount of air being used to cool the laptop computer as to bring the parameters back below the selected level or within the desired ranges.
